(19) United States
(12) Patent Application Publication
(10) Pub. No.: US 2005/0016997 A1
(43) Pub. Date: Jan. 27, 2005

(54) Microwave food box

(76) Inventor: Tong Chang Wang, Taipei Hsien (TW)

Correspondence Address: Wang, Tong Chang, 235 Chung-Ho, Box 8-24, Taipei, TW

(21) Appl. No.: 10/923,756

(22) Filed: Aug. 23, 2004

(30) Foreign Application Priority Data
Feb. 12, 2003 (TW) 92221176

(51) Int. Cl. H05B 6/80

(52) U.S. Cl. 219/734

(57) ABSTRACT

A microwave food box comprises an upper cover having an upper edge; at least one protrusion being formed on the upper edge; a lower box; wherein when the upper cover is combined with the lower box; at least one ventilating channel being formed between each of the protrusion and the lower box for ventilating hot airflow from the ventilating channel. The at least one protrusion is extended toward the lower box so as to prevent other object from flowing into the microwave food box and to prevent objects in the microwave food box from flowing out.

### FIELD OF THE INVENTION

The present invention relates to tools about microwave ovens; and particular to a microwave food box comprises an upper cover having an upper edge; at least one protrusion being formed on the upper edge; a lower box; wherein when the upper cover is combined with the lower box; at least one ventilating channel being formed between each of the protrusion and the lower box for ventilating hot airflow from the ventilating channel.

### BACKGROUND OF THE INVENTION

Currently, fast foods have become a main way in food since people has no too much time to cook. However, microwave foods have been a popular way. Many kinds of microwave food boxes are developed for fast foods, as shown in FIG. 1. Generally, to avoid too high temperature to have a great pressure so that the box explodes, a plurality of venting openings 112 are formed on a top surface 111 of the upper cover 11. However, external objects are easy to enter into the box from the openings 112 or the objects in the box will flow out from the openings so as to make trouble to users.

### SUMMARY OF THE INVENTION

Accordingly, the primary object of the present invention is to provide a microwave food box which comprises an upper cover having an upper edge; at least one protrusion being formed on the upper edge; a lower box; wherein when the upper cover is combined with the lower box; at least one ventilating channel being formed between each of the protrusion and the lower box for ventilating hot airflow from the ventilating channel. The at least one protrusion is extended toward the lower box so as to prevent other object from flowing into the microwave food box and to prevent objects in the microwave food box from flowing out.

The various objects and advantages of the present invention will be more readily understood from the following detailed description when read in conjunction with the appended drawing.

### BRIEF DESCRIPTION OF THE DRAWINGS

FIG. 1 is a perspective view about the prior art food box.

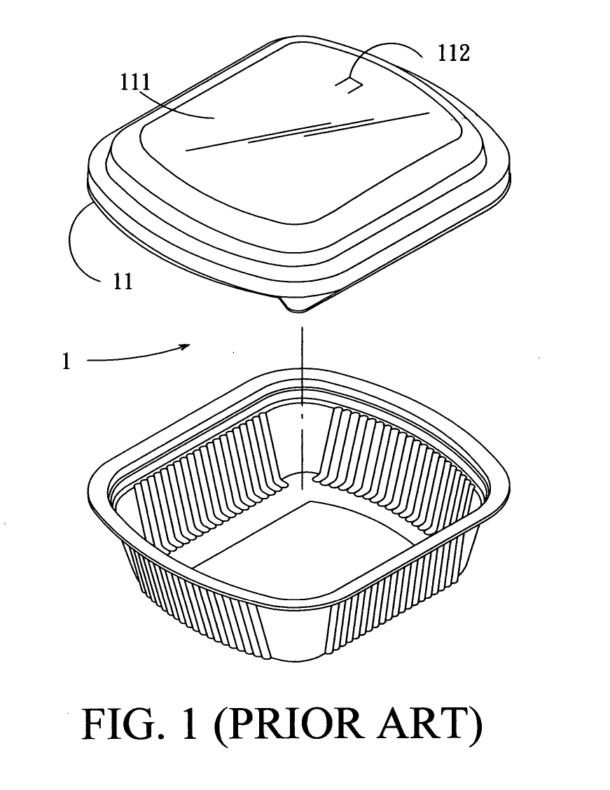

FIG. 2 is a perspective view the present invention.

FIG. 3 is an exploded view of the present invention.

FIG. 4 is a schematic view showing the ventilating channels of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

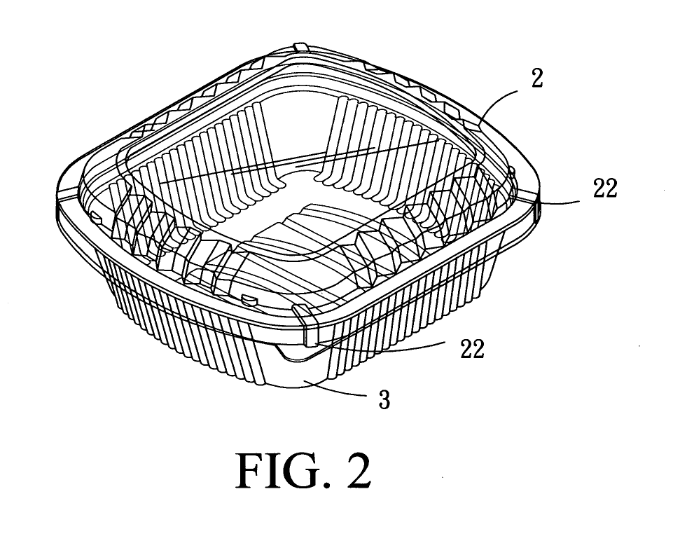

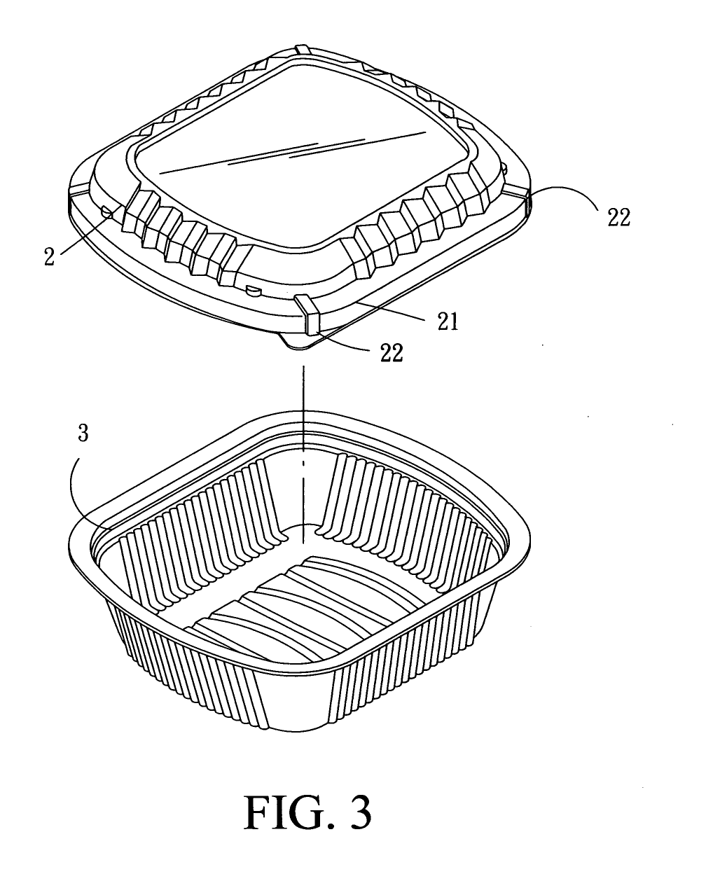

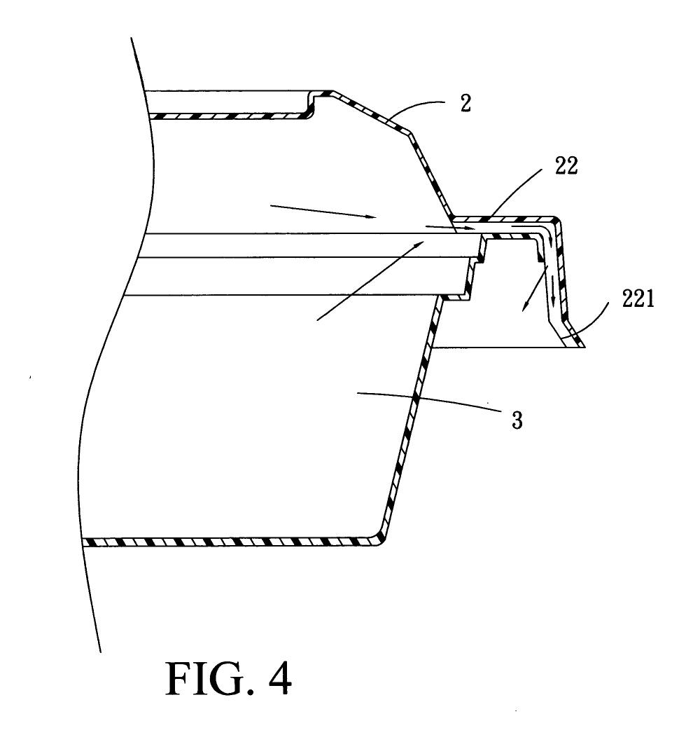

With reference to FIGS. 2 to 4, the microwave food box of the present invention is illustrated. The microwave food box has the following elements.

An upper cover 2 has an upper edge 21. At least one protrusion 22 is formed on the upper edge 21.

A lower box 3 is includes. When the upper cover 2 is combined with the lower box 3, a ventilating channel 221 is formed between each of the protrusion 22 and the lower box 3. Thereby, when the microwave food box of the present invention is processed with microwave oven. The hot air can flow out from the ventilating channel 221 so as to prevent the microwave food box from explosion due to high temperature. Besides, in one embodiment of embodiment, the protrusion is extended toward the lower box 3 so as to prevent other object from flowing into the microwave food box and to prevent objects in the microwave food box from flowing out.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A microwave food box comprising;
an upper cover having an upper edge; at least one protrusion being formed on the upper edge;
a lower box; wherein when the upper cover is combined with the lower box; at least one ventilating channel being formed between each of the protrusion and the lower box for ventilating hot airflow from the ventilating channel.

2. The microwave food box as claimed in claim 1, wherein the at least one protrusion is extended toward the lower box so as to prevent other object from flowing into the microwave food box and to prevent objects in the microwave food box from flowing out.
